(19) United States
(12) Patent Application Publication
(10) Pub. No.: US 2026/0250168 A1
(43) Pub. Date: Aug. 27, 2026

(54) Adaptive critic control algorithm integrating knowledge transfer for wastewater treatment process

(71) Applicant: BEIJING UNIVERSITY OF TECHNOLOGY, BEIJING (CN)

(72) Inventors: Ding Wang, BEIJING (CN); Xin Li, BEIJING (CN); Mingming Zhao, BEIJING (CN); Ao Liu, BEIJING (CN)

(21) Appl. No.: 19/187,578

(22) Filed: Apr. 23, 2025

(30) Foreign Application Priority Data
Feb. 26, 2025 (CN) 202510212804.6

(51) Int. Cl. C02F 3/00; C02F 3/30; C02F 101/16; C02F 101/30

(52) U.S. Cl. CPC C02F 3/006; C02F 3/301; C02F 3/302; C02F 2101/163; C02F 2101/30; C02F 2209/006; C02F 2209/22

(57) ABSTRACT

An adaptive critic control algorithm integrating knowledge transfer for a wastewater treatment process is provided. This algorithm is used to achieve precise tracking of the dissolved oxygen concentration to the set value during the wastewater treatment process. When realizing the optimal control of a wastewater treatment system with an unknown model, the direct control strategy in the conventional adaptive critic control (ACC) algorithm is often sensitive to system disturbances, which may lead to a sharp decline in control performance. The present invention takes both knowledge transfer and incremental control into consideration. First, the anti-interference performance is effectively improved by optimizing the control strategy of the conventional ACC algorithm into an incremental form. Second, by leveraging the historical operation data of the system, knowledge transfer is implemented among different control methods. As a result, the initial control performance of the present invention during the early training stage has been effectively improved. Thirdly, a new type of utility function with a soft strategy constraint mechanism is designed, which enhances the stability during the online optimization process. Finally, the effectiveness of the present invention has been verified through experiments.

### CROSS-REFERENCE TO RELATED APPLICATION

The present application claims the priority benefit to Chinese Patent Application No. 202510212804.6 filed on Feb. 26, 2025. The entire contents of the above identified application are incorporated herein by reference.

### TECHNICAL FIELD

The present invention relates to the field of wastewater treatment.

### BACKGROUND ART

With the acceleration of the urbanization process and the continuous increase of population density, the discharge amount of urban wastewater is rapidly increasing, posing a severe challenge to the urban water environment. As a crucial link in protecting the environment and promoting the recycling of water resources, the significance of wastewater treatment is self-evident. Effective wastewater treatment can not only protect the ecological balance but also provide a reliable way for the reuse of water resources in cities, which has far-reaching significance for promoting sustainable development and constructing a society of ecological civilization. Therefore, optimizing the wastewater treatment process and improving the treatment efficiency are important issues that urgently need to be solved in the current environmental protection field.

Precise regulation of the dissolved oxygen (DO) concentration is crucial for ensuring the efficient and stable operation of the wastewater treatment process. Some traditional control methods like proportional-integral-derivative (PID) control, on-off control, and feedforward control can regulate the DO concentration to some extent. However, wastewater treatment processes feature complex and variable working conditions, including fluctuations in influent flow rate, changes in water temperature, and differences in sludge load. Traditional control methods struggle to adapt to these uncertain changes during actual operation. As a result, the control effect of these control methods is unstable and the energy consumption is relatively high. In addition, traditional control methods do not have the optimization ability and are difficult to meet the increasingly stringent effluent water quality standards and the requirements for energy conservation and emission reduction.

In view of this, exploring more intelligent and efficient control methods has become a research hotspot in the field of wastewater treatment. Relevant researchers have begun to design controllers for the wastewater treatment process based on intelligent control methods such as neural network control and model predictive control. However, neural network control only adjusts the weights according to the tracking error at the current moment, resulting in limited optimization ability; model predictive control has good optimization performance because it takes into account the long-term tracking error in the future, but it has a strong dependence on an accurate system model. The adaptive critic control (ACC) algorithm, due to its powerful optimization and adaptive performance, is widely applied to the control and optimization problems of unknown nonlinear systems. The ACC algorithm can continuously optimize the control strategy during the iterative process by combining the ideas of dynamic programming and reinforcement learning. The ACC algorithm can automatically adjust parameters based on real-time operation data when the system model is unknown, so as to adapt to the changes in the system state and achieve a satisfactory control effect. Applying the ACC algorithm in the wastewater treatment process is expected to improve the control accuracy of the DO concentration, which is of great significance for ensuring the wastewater treatment efficiency.

Although the ACC algorithm shows great potential in theory, when it is actually applied to the wastewater treatment process, it still faces a series of challenges. Firstly, the direct control strategy of the conventional ACC algorithm is only related to the current system state. When the wastewater treatment system controlled by the conventional ACC algorithm is disturbed, the control accuracy of the DO concentration will be greatly affected. Secondly, the training data of the conventional ACC algorithm need to be obtained through gradual interaction with the system. This often puts the algorithm in a dilemma of lacking training data, which in turn leads to a slow convergence speed of the algorithm and poor learning stability. To solve this problem, scholars usually introduce an experience replay mechanism to stabilize the learning process by storing historical experience data. However, this approach significantly increases the burden of data storage and calculation, which is not conducive to the widespread application of the ACC algorithm in practical engineering. In summary, although the ACC algorithm provides a new idea for the DO concentration control in the urban wastewater treatment process, there are still many challenges in its direct application. How to overcome the problems of sensitivity to disturbances, poor learning stability, and heavy storage and calculation burdens while maintaining the optimization and adaptive advantages of the ACC algorithm has become the key to current research.

### CONTENTS OF THE INVENTION

In comparison with the conventional ACC algorithm, the present invention makes an improvement to the control strategy by shifting it from a direct type to an incremental type. This modification effectively enhances the anti-interference performance of the present invention in the wastewater treatment system. At the same time, the expert experience in the traditional incremental PID control algorithm and the knowledge transfer technology are used to construct the initial control strategy of the present invention, overcoming the problem of slow convergence of the conventional ACC algorithm. In order to avoid the data storage pressure caused by the experience replay mechanism, the present invention innovatively designs a new utility function with a soft strategy constraint mechanism. While avoiding the increase of the data storage burden, it can improve the stability of the online optimization process of the present invention. Finally, the experimental results show that the present invention has good control performance for the DO concentration in the wastewater treatment process.

The structural diagram of the wastewater treatment system employing the present invention is shown in FIG. 1, though the system is not limited to this specific configuration. In FIG. 1, component 1.1 denotes the biological reactor, which serves as the core unit for biochemical wastewater treatment. This reactor adopts a specialized structural design to facilitate various biochemical reactions. Component 1.2 represents the anoxic section, comprising tanks 1.4 and 1.5. Within component 1.2, anaerobic microorganisms utilize organic matter in the wastewater as carbon sources to reduce nitrate to nitrogen gas, effectively removing nitrogen compounds from the wastewater. Component 1.3 stands for the aerated section, consisting of tanks 1.6, 1.7, and 1.8. In component 1.3, aerobic microorganisms decompose complex organic substances into harmless compounds such as carbon dioxide and water through respiration. Additionally, nitrification occurs in component 1.3, where ammonia nitrogen in the wastewater is oxidized to nitrate by nitrifying bacteria. Component 1.9 indicates the secondary clarifier, which separates sludge from treated wastewater through sedimentation. The sludge settled at the bottom can be recirculated to the biological reactor to maintain biomass concentration or discharged as excess sludge for further treatment.

Meanwhile, component 2.1 is the DO concentration sensor installed in tank 1.8. This sensor is employed for real-time continuous monitoring of the DO concentration and converts measured values into electrical signals for transmission. Component 2.2 denotes the programmable logic controller (PLC), which executes control algorithms and performs digital-to-analog/analog-to-digital conversions. Component 2.3 represents the frequency converter that precisely adjusts the power frequency supplied to the blower motor based on control signals received from the PLC 2.2. Component 2.4 is the blower, which supplies air to the aerated section of the biological reactor, thereby regulating the oxygen transfer coefficient in tank 1.8.

Upon entering the wastewater treatment system, urban wastewater first flows through the anoxic section 1.2. Here, denitrification reactions occur, removing substantial amounts of nitrogen from the wastewater. The wastewater then proceeds to the aerated section 1.3, where simultaneous processes take place: aerobic microorganisms degrade organic pollutants while nitrifying bacteria convert ammonia nitrogen into nitrate nitrogen. Subsequently, the wastewater enters the secondary clarifier 1.9 for sedimentation. Throughout these biochemical reactions, the DO concentration in tank 1.8 is a critical factor. If the DO concentration is too low, the metabolic activity of aerobic microorganisms significantly decreases, thereby reducing the degradation rate of organic pollutants. As a result, the overall wastewater treatment efficiency declines substantially. On the other hand, excessively high DO concentrations not only cause energy waste due to unnecessary oxygen supply but may also promote the growth of harmful microorganisms, negatively impacting treatment performance.

Therefore, based on the TACC algorithm and devices such as the DO concentration sensor 2.1, the PLC 2.2, the frequency converter 2.3, and the blower 2.4, the present invention precisely regulates the oxygen transfer coefficient and aims to maintain the DO concentration near the setpoint, which is crucial for the efficient operation of the wastewater treatment process.

During actual operation of the wastewater treatment system implementing the present invention, the DO concentration sensor 2.1 continuously monitors and collects DO concentration data from tank 1.8. The acquired data is transmitted to the PLC 2.2. Upon receiving the data, the PLC 2.2 first calculates the actual oxygen transfer coefficient in tank 1.8. Subsequently, based on the input DO concentration data and the TACC algorithm, the PLC 2.2 computes the desired oxygen transfer coefficient required for the current wastewater treatment system. After obtaining the target oxygen transfer coefficient, the PLC 2.2 immediately determines the deviation between the actual and desired coefficients. The controller then generates a corresponding output signal proportional to this deviation and transmits it to the frequency converter 2.3. The frequency converter 2.3 responds promptly upon receiving the signal, precisely adjusting its output frequency to the blower 2.4 motor in accordance with the command signal. This frequency variation directly affects the rotational speed of the blower 2.4 motor. As the blower's rotational speed changes, the air supply volume to the wastewater is accordingly modulated. By increasing or decreasing the aeration rate, the system effectively regulates the actual oxygen transfer coefficient to achieve the optimal value. Under the influence of this optimized oxygen transfer coefficient, the DO concentration in tank 1.8 undergoes precise adjustment. Ultimately, the DO concentration stabilizes and is maintained within the desired range, ensuring optimal performance of the wastewater treatment system.

The overall implementation process of the present invention is as follows: First, in Step 1, formulate the optimal tracking problem for the DO concentration in the wastewater treatment system. Second, in Step 2, initialize the control strategy using knowledge transfer technology.

Third, repeatedly execute Step 3 to precisely control the DO concentration in the wastewater treatment system and optimize the control strategy online. Subsequently, the present invention details the implementation procedures for each step.

Step 1: Establish the optimal tracking problem regarding the DO concentration in the wastewater treatment process. The wastewater treatment system can be represented as a class of nonlinear system as follows:

$${x}_{k + 1} = H ( {x}_{k} , {u}_{k} ) , k = 0 , 1 , 2 , … \qquad ( 1 )$$

where the system state xₖ∈ [symbol] represents the DO concentration in the tank 1.8 at the kth moment, the control input uₖ∈ [symbol] represents the oxygen transfer coefficient at the kth moment, H(⋅,⋅) represents the unknown wastewater treatment system function, and [symbol] represents the set of all non-negative real numbers. The set value dₖ of the DO concentration is expressed as

$${d}_{k} = δ ( k ) \qquad ( 2 )$$

where δ(⋅) is the set value function. According to engineering experience, the set value of the DO concentration is usually selected as 2 mg/L. The tracking error eₖ between the DO concentration and its set value is defined as

$${e}_{k} = {x}_{κ} - {d}_{k} \qquad ( 3 )$$

In the conventional ACC algorithm, the calculated control strategy is a direct control strategy π(eₖ), such that the control input uₖ=π(eₖ). In order to enhance the anti-interference ability of the conventional ACC algorithm, the present invention designs an incremental control strategy η(eₖ), such that the control input satisfies the following equation:

$$\{ \begin{matrix}Δ {u}_{k} = η ( {e}_{k} ) \\ {u}_{k} = {u}_{k - 1} + Δ {u}_{k}\end{matrix} \qquad ( 4 )$$

In addition, in order to enhance the stability of the learning process, a utility function is proposed as follows:

$$U ( {e}_{k} , Δ {u}_{k} ) = {α}_{1} {e}_{k}^{2} + {α}_{2} Δ {U}_{k}^{2} + {α}_{3} S ( {e}_{k} , Δ {u}_{k} ) \qquad ( 5 )$$

where α₁, α₂, and α₃ are constant weights greater than 0. In the present invention, α₁=0.1, α₂=0.01, and α₃=0.005. For the utility function U(eₖ,Δuₖ), α₁eₖ² mainly reflects the cost due to the tracking error and directly ensures the control accuracy; α₂Δuₖ² focuses on reflecting the cost brought about by the change of the control input, and is used to avoid excessive fluctuations of the control input and ensure the smoothness of the control process. In addition, S(eₖ,Δuₖ) is a soft strategy constraint function innovatively designed by the present invention, which plays a key role in the adaptive soft strategy constraint during the optimization process of the control strategy, and it is expressed as

$$S ( {e}_{k} , Δ {u}_{k} ) = {{e}_{k}^{2} ( Δ {u}_{k} - ϑ ( {e}_{k} ) )}^{2} \qquad ( 6 )$$

where ϑ(eₖ) represents any stable incremental PID control strategy in the wastewater treatment system. Here, ϑ(eₖ)=−121eₖ+102eₖ₋₁−eₖ₋₂. When the optimization effect of the control strategy is remarkable, at this time the value of eₖ² is less than or equal to 1×10⁻², and the term S(eₖ,Δuₖ) will automatically relax the restrictions on the strategy optimization process, giving the control strategy greater adjustment freedom to fully exert its optimization performance; on the contrary, if the optimization effect is poor resulting in low control accuracy, at this time the value of eₖ² is greater than or equal to 1×10⁻², the term S(eₖ,Δuₖ) will strengthen the constraint on the strategy optimization process, guiding the control strategy η(eₖ) to approach the incremental PID control strategy ϑ(eₖ), enabling the present invention to balance stability while optimizing the control accuracy, thus ensuring the reliable operation of the entire control system. Then, the value function V(eₖ,Δuₖ) is defined as

$$V ( {e}_{k} , Δ {u}_{k} ) = {\sum }_{p = k}^{∞} {γ}^{ρ - k} U ( {e}_{ρ + 1} , Δ {u}_{p + 1} ) = U ( {e}_{k + 1} , Δ {u}_{k + 1} ) + γ V ( {e}_{k + 1} , Δ {u}_{k + 1} ) \qquad ( 7 )$$

where γ∈(0,1) is the discount factor, which is used to ensure the boundedness of the value function. Here, γ=0.95. The optimal value function V*(eₖ,Δuₖ) and the optimal incremental control strategy η*(eₖ) are respectively defined as

$${V}^{*} ( {e}_{k} , Δ {u}_{k} ) = {min}_{Δ {u}_{k}} \{ U ( {e}_{k + 1} , Δ {u}_{k + 1} ) + γ {V}^{*} ( {e}_{k + 1} , Δ {u}_{k + 1} ) \} \qquad ( 8 )$$

and

$${η}^{*} ( {e}_{k} ) = arg {min}_{Δ {u}_{k}} \{ U ( {e}_{k + 1} , Δ {u}_{k + 1} ) + γ {V}^{*} ( {e}_{k + 1} , Δ {u}_{k + 1} ) \} \qquad ( 9 )$$

Since (8) belongs to the Hamilton-Jacobi-Bellman equation, it is difficult to directly obtain its analytical solution. Therefore, based on the action-critic online optimization mechanism and the function approximation capability of the neural network, the present invention can continuously approach the optimal value function V*(eₖ,Δuₖ) and the optimal incremental control strategy η*(eₖ).

Step 2: Complete the initialization of the control strategy using knowledge transfer technology. The present invention is composed of an action network and a critic network. The action network is used to approximate the optimal incremental control strategy η*(eₖ), and the critic network is used to approximate the optimal value function V*(eₖ,Δuₖ). It should be noted that both the action network and the critic network are back-propagation neural networks composed of an input layer, a hidden layer, and an output layer. Therefore, the initialization of the control strategy can be completed by pre-training the action network.

In order to complete the initialization of the control strategy using the knowledge transfer technology, the present invention first establishes a dataset D={(e′ⱼ,Δu′ⱼ)|j=1, 2, . . . , n} using the historical operation data of the wastewater treatment system under the action of the incremental PID control algorithm ϑ(eₖ), where e′ⱼ and Δu′ⱼ respectively represent the j-th tracking error sample and the incremental control input sample, and n is the total number of samples in the dataset D. In the present invention, n=2687, but it is not limited to this value. Then, the pre-training of the action network is completed based on the dataset D.

During the pre-training process, the output of the action network can be expressed as

$$\hat{η} ( {e}_{j}^{′} ) = {w}_{a 2}^{T} ϕ ( {w}_{a 1}^{T} {e}_{j}^{′} ) \qquad ( 10 )$$

where wₐ₁(k)∈ [symbol] and wₐ₂(k)∈ [symbol] are the weight vectors of the action network. hₐ=10 represents the number of neurons in the hidden layer of the action network. Additionally, the activation function φ(⋅) is set as the hyperbolic tangent function. The approximation error of the action network during the pre-training process can be expressed as

$$ξ ( {e}_{j}^{′} ) = \hat{η} ( {e}_{j}^{′} ) - Δ {u}_{j}^{′} \qquad ( 11 )$$

The performance index function of the action network during the pre-training process can be expressed as (d)

$$Ψ ( {e}^{′} ) = \frac{1}{n} {\sum }_{j = 1}^{n} \frac{1}{2} {ξ}^{2} ( {e}_{j}^{′} ) \qquad ( 12 )$$

where e′32 [e′₁, e′₂, . . . , e′ₙ] is the input of the performance index function. According to the gradient-descent principle, the update rule of the action network weights during the pre-training process can be expressed as

$${w}_{a 1} := {w}_{a 1} - {β}_{a} \frac{\partial Ψ ( {e}^{′} )}{\partial {w}_{a 1}} \qquad ( 13 )$$

$${w}_{a 2} := {w}_{a 2} - {β}_{a} \frac{\partial Ψ ( {e}^{′} )}{\partial {w}_{a 2}}$$

where := represents the assignment operation, and βₐ=0.005 is the learning rate of the action network during the pre-training process. Repeat the execution of (10)-(13) until Ψ(e′)<10⁻⁵. At this time, the present invention has successfully completed the knowledge transfer from the PID control algorithm to the present invention based on the dataset D, improving the control performance of the DO concentration in the initial stage.

Step 3: Online optimization of the control strategy based on the action-critic framework. To ensure the adaptability and optimization performance of the algorithm, the present invention continuously updates the value function and improves the policy according to the real-time tracking error eₖ. During the online training process, the output of the critic network can be expressed as

$$\hat{V} ( {e}_{k} , \hat{η} ( {e}_{k} ) ) = {w}_{c 2}^{T} ϕ ( {{w}_{c 1}^{T} [ {e}_{k} , \hat{η} ( {e}_{k} ) ]}^{T} ) \qquad ( 14 )$$

where w_{c1}∈ [symbol] and w_{c2}∈ [symbol] are the weight vectors of the critic network. h_{c}=12 represents the number of hidden layer neurons in the critic network. During the online training process, the approximation error of the critic network can be expressed as

$${ε}_{c} ( {e}_{k} ) = γ \hat{V} ( {e}_{k} , Δ {u}_{k} ) - ( \hat{V} ( {e}_{k - 1} , Δ {u}_{k - 1} ) - U ( {e}_{k} , Δ {u}_{k} ) ) \qquad ( 15 )$$

The performance index of the critic network can be expressed as

$${E}_{c} ( {e}_{k} ) = \frac{1}{2} {ε}_{c}^{2} ( {e}_{k} ) \qquad ( 16 )$$

According to the principle of gradient descent, the update rule of the weight vector w_{c2} can be expressed as

$${w}_{c 2} := {w}_{c 2} - {I}_{c} \frac{\partial {E}_{c} ( {e}_{k} )}{\partial {w}_{c 2}} \qquad ( 17 )$$

where l_{c}=0.01 is the learning rate during the online training process of the critic network. It is worth noting that, in order to reduce the computational burden of online training, the present invention only updates the weight w_{c2}, and the weight w_{c1} remains unchanged after being randomly initialized. Repeat steps (14)-(17) until E_{c}(eₖ)<10⁻⁵. At this point, the update of the critic network at k moment is completed. Next, based on the evaluation results of the control strategy by the critic network, the policy improvement is completed. During the online training process, the output of the action network can be expressed as

$$\hat{η} ( {e}_{k} ) = {w}_{a 2}^{T} ϕ ( {w}_{a 1}^{T} {e}_{k} ) \qquad ( 18 )$$

During the online training process, the approximation error of the action network is defined as

$${ε}_{a} ( {e}_{k} ) = \hat{V} ( {e}_{k} , Δ {u}_{k} ) - {U}_{d} \qquad ( 19 )$$

where U_{d} is the ideal training target. Here, U_{d}=0. The performance index of the action network during the online training process is defined as

$${E}_{a} ( {e}_{k} ) = \frac{1}{2} {ε}_{a}^{2} ( {e}_{k} ) \qquad ( 20 )$$

According to the principle of gradient descent, the update rule of the weight vector wₐ₂ can be expressed as

$${w}_{a 2} := {w}_{a 2} - {I}_{a} \frac{\partial {E}_{a} ( {e}_{k} )}{\partial {w}_{a 2}} \qquad ( 21 )$$

Repeat steps (18)-(21) until |∂Eₐ(eₖ)/∂wₐ₂|<10⁻³. At this point, the optimization of the action network at k moment is completed. Finally, use the well-trained action network to calculate the control input based on the current tracking error.

$$\{ \begin{matrix}Δ {u}_{k} = \hat{η} ( {e}_{k} ) \\ {u}_{k} = {u}_{k - 1} + Δ {u}_{k}\end{matrix} \qquad ( 22 )$$

The control input Uₖ represents the ideal oxygen transfer coefficient of the wastewater treatment system at a certain moment. Once the programmable logic controller 2.2 obtains the ideal value, it instantly calculates the difference between the ideal and actual oxygen transfer coefficients. Then, it generates an output signal based on this difference and sends it to the frequency converter 2.3. Upon receiving the output signal, the frequency converter 2.3 responds promptly and precisely adjusts its output frequency to the blower 2.4. By doing so, the motor speed of the blower is regulated, thereby changing the amount of air delivered to the tank 1.8 and enabling the actual oxygen transfer coefficient to reach the ideal value. Under the action of the ideal oxygen transfer coefficient, the DO concentration in the tank 1.8 is precisely regulated and stabilized near the set value, ensuring the best wastewater treatment effect.

### DESCRIPTION OF THE DRAWINGS

FIG. 1 is the structural diagram of the wastewater treatment system based on the present invention.

FIG. 2 shows the approximation error of the action network after pre-training.

FIG. 3 shows the change process of the DO concentration under the action of different control algorithms.

FIG. 4 shows the change process of the oxygen transfer coefficient of the present invention

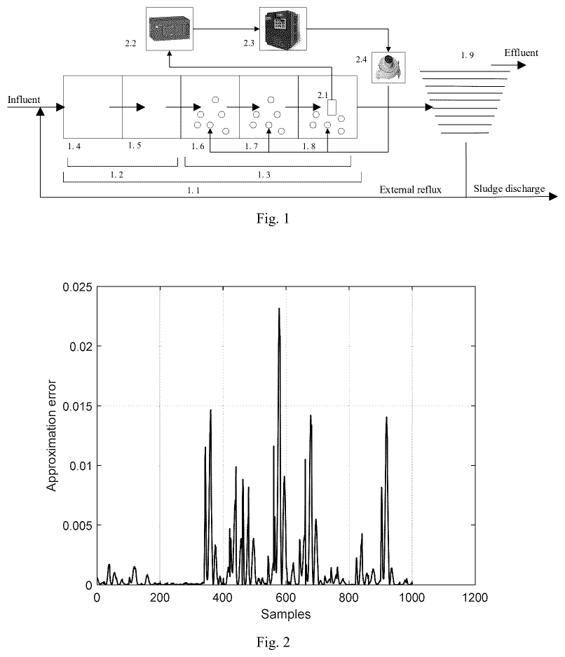

### SPECIFIC EMBODIMENTS

The present invention is applied to the wastewater treatment system for 14 days, with a sampling time interval of Δk=45 s, so as to evaluate the control performance of the present invention on the DO concentration during the wastewater treatment process. According to the algorithm debugging experience, the parameter values of the algorithm proposed in the present invention are selected as follows:
(1) The set value dₖ=2, the constant weights α₁=0.1, α₂=0.01, α₃=0.005, and the discount factor γ=0.95;
(2) The total number n=2687 of samples in the data set D, the pre-training learning rate βₐ=0.005, the pre-training stop criterion Ψ(e′)<10−5, and the number of hidden layer neuron nodes hₐ=10, h_{c}=12;
(3) The online training learning rates l_{c}=0.01, lₐ=0.01, and the online training stop criteria E_{c}(eₖ)<10⁻⁵, |∂E(eₖ)/∂wₐ₂|<10⁻³.

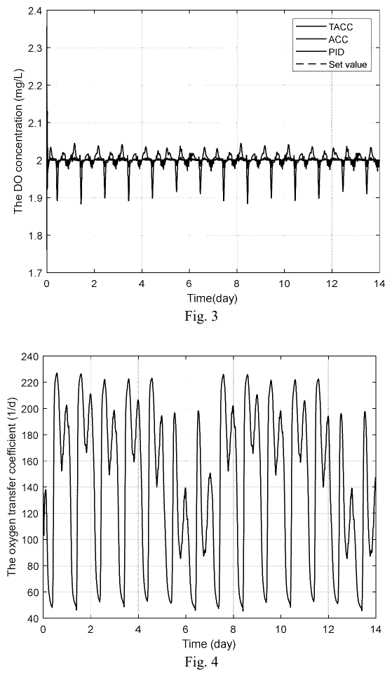

After completing the pre-training stage of the action network, 600 groups of data are used to test its approximation accuracy to the PID control strategy. The test results are shown in FIG. 2. The approximation error is controlled within 0.025, demonstrating good approximation accuracy. To visually display the superior performance of the present invention, it is comprehensively compared with the traditional PID control algorithm and the conventional ACC algorithm in terms of the control effect on the DO concentration. The experimental results are shown in FIG. 3. Compared with the other two control algorithms, the present invention has higher control accuracy for the DO concentration and smaller error fluctuations. In addition, the change process of the oxygen transfer coefficient, which is used as the control input in the present invention, is shown in FIG. 4.

In order to evaluate the control performance of the algorithm more accurately, the present invention further conducts a quantitative analysis of the control performance of the algorithm using two industry-recognized evaluation indicators: the integral of squared error (ISE) and the maximal deviation from the set value (Dev^{max}). The definitions of these two indicators are as follows:

$$\{ \begin{matrix}ISE = \frac{1}{{k}_{2} - {k}_{1}} {\sum }_{k = {k}_{1}}^{{k}_{2}} {e}_{k}^{2} \\ D e {v}^{max} = max \{ \vert {e}_{k} \vert \vert k ∈ ( {k}_{1} , {k}_{2} ) \}\end{matrix} \qquad ( 23 )$$

where k₁ and k₂ represent the start time and end time for statistically calculating the tracking error between the DO concentration and the set value, respectively. According to industry experience, data from the last 7 days of 14 days are usually statistically analyzed. That is, k₁ represents the start time of the 8th day, and k₂ is the end time of the 14th day. The ISE mainly reflects the average control accuracy of the present invention for the DO concentration over a long-term scale. The smaller its value, the better the average control effect. The Dev^{max} focuses on reflecting the degree of fluctuation in the control of the DO concentration by the present invention. The smaller the value, the higher the control stability. Under the action of the PID control algorithm, ISE=5.64×10⁻⁴ and Dev^{max}=0.1164. Under the action of the conventional ACC control algorithm, ISE=1.90×10⁻⁵ and Dev^{max}=0.0223. Under the action of the present invention, ISE=3.19×10⁻⁶ and Dev^{max}=0.0084. From the comparison of these data, it can be seen that the present invention has significant improvements in both average control accuracy and stable control performance, which effectively verifies its application value and innovative advantages in the field of DO concentration control during the wastewater treatment process.

The present invention enhances the anti-interference ability by improving the control strategy to an incremental form, enabling it to better cope with complex working conditions. It utilizes knowledge transfer technology and traditional incremental PID control experience to construct the initial strategy, effectively reducing the training cost. A new type of utility function is designed, which effectively guarantees the stability of online optimization without causing a data storage burden. The experimental results show that, compared with the traditional PID control algorithm and the general ACC algorithm, the present invention has a relatively obvious improvement in control accuracy. It can make the DO concentration track the set value more accurately, effectively reduce error fluctuations, and ensure the efficient and stable operation of the wastewater treatment process.

We claim:

1. An adaptive critic control method for a wastewater treatment process that integrates knowledge transfer, comprising following steps:
Step 1: establish an optimal tracking problem regarding dissolved oxygen (DO) concentration in the wastewater treatment process;
a wastewater treatment system can be represented as a class of nonlinear system as follows:
$${x}_{k + 1} = H ( {x}_{k} , {U}_{k} ) , k = 0 , 1 , 2 , … \qquad ( 1 )$$
where a system state xₖ∈ [symbol] represents DO concentration in a tank (1.8) at k moment, a control input uₖ∈ [symbol] represents oxygen transfer coefficient at the k moment, H(⋅,⋅) represents an unknown wastewater treatment system function, and [symbol] represents a set of all positive real numbers; a set value dₖ of the DO concentration is expressed as
$${d}_{k} = δ ( k ) \qquad ( 2 )$$
where δ(⋅) is a set value function; according to engineering experience, the set value of the DO concentration is usually selected as 2 mg/L; a tracking error e between the DO concentration and its set value is defined as
$${e}_{K} = {x}_{k} - {d}_{k} \qquad ( 3 )$$
design an incremental control strategy η(eₖ), such that the control input satisfies the following equation:
$$\{ \begin{matrix}Δ {u}_{k} = η ( {e}_{k} ) \\ {u}_{k} = {u}_{k - 1} + Δ {u}_{k}\end{matrix} \qquad ( 4 )$$
a utility function is proposed as follows:
$$U ( {e}_{μ} , Δ {u}_{k} ) = {α}_{1} {e}_{k}^{2} + {α}_{2} Δ {u}_{k}^{2} + {α}_{3} S ( {e}_{k} , Δ {u}_{k} ) \qquad ( 5 )$$
where α₁, α₂, and α₃ are constant weights greater than 0; S(eₖ,Δuₖ) is defined as
$$S ( {e}_{k} , Δ {u}_{k} ) = {{e}_{k}^{2} ( Δ {u}_{k} - ϑ ( {e}_{k} ) )}^{2} \qquad ( 6 )$$
with ϑ(e)=−121eₖ+102eₖ₋₁−eₖ₋₂;
a value function V(eₖ,Δuₖ) is defined as
$$V ( {e}_{k} , Δ {u}_{k} ) = {\sum }_{p = k}^{∞} {r}^{p - k} U ( {e}_{p + 1} , Δ {u}_{p + 1} ) = U ( {e}_{k + 1} , Δ {u}_{k + 1} ) + γ V ( {e}_{k + 1} , Δ {u}_{k + 1} ) \qquad ( 7 )$$
where γ∈(0,1) is a discount factor;
an optimal value function V*(eₖ,Δuₖ) and an optimal incremental control strategy η*(eₖ) are respectively defined as
$${V}^{*} ( {e}_{k} , Δ {u}_{k} ) = {min}_{Δ {u}_{k}} \{ U ( {e}_{k + 1} , Δ {u}_{k + 1} ) γ {V}^{*} ( {e}_{k + 1} , Δ {u}_{k + 1} ) \} \qquad ( 8 )$$
and
$${η}^{*} ( {e}_{k} ) = arg {min}_{Δ {u}_{k}} \{ U ( {e}_{k + 1} , Δ {u}_{k + 1} ) + γ {V}^{*} ( {e}_{k + 1} , Δ {u}_{k + 1} ) \} \qquad ( 9 )$$
based on an action-critic online optimization mechanism and function approximation capability of a neural network, wastewater treatment process can continuously approach the optimal value function V*(eₖ,Δuₖ) and the optimal incremental control strategy η*(eₖ);
Step 2: complete initialization of the control strategy using knowledge transfer technology;
an action network is used to approximate the optimal incremental control strategy η*(eₖ), and a critic network is used to approximate the optimal value function V*(eₖ,Δuₖ); both the action network and the critic network are back-propagation neural networks composed of an input layer, a hidden layer, and an output layer;
establish a dataset D={(e′ⱼ,Δu′ⱼ)|j=1, 2, . . . , n} using historical operation data of the wastewater treatment system under the action of an incremental PID control algorithm ϑ(eₖ), where e′ⱼ and Δu′ⱼ respectively represent j-th tracking error sample and incremental control input sample, and n is a total number of samples in the dataset D; a pre-training of the action network is completed based on the dataset D; during the pre-training process, an output of the action network can be expressed as
$$\hat{η} ( {e}_{j}^{′} ) = {w}_{a 2}^{T} ϕ ( {w}_{a 1}^{T} {e}_{j}^{′} ) \qquad ( 10 )$$
where wₐ₁(k)∈ [symbol] and wₐ₂(k)∈ [symbol] are weight vectors of the action network; hₐ=10 represents the number of neurons in the hidden layer of the action network; an activation function φ(⋅) is set as hyperbolic tangent function; an approximation error of an execution network during the pre-training process can be expressed as
$$ξ ( {e}_{j}^{′} ) = \hat{η} ( {e}_{j}^{′} ) - Δ {u}_{j}^{′} \qquad ( 11 )$$
a performance index function of the execution network during the pre-training process can be expressed as
$$Ψ ( {e}^{′} ) = \frac{1}{n} {\sum }_{j = 1}^{n} \frac{1}{2} {ξ}^{2} ( {e}_{j}^{′} ) \qquad ( 12 )$$
where e′=[e′₁, e′₂, . . . , e′ₙ] is an input of the performance index function; an update rule of the execution network weights during the pre-training process can be expressed as
$${w}_{a 1} := {w}_{a 1} - {β}_{a} \frac{\partial Ψ ( {e}^{′} )}{\partial {w}_{a 1}} \qquad ( 13 )$$
$${w}_{a 2} := {w}_{a 2} - {β}_{a} \frac{\partial Ψ ( {e}^{′} )}{\partial {w}_{a 2}}$$
where := represents assignment operation, and βₐ=0.005 is a learning rate of the action network during the pre-training process; repeat the execution of (10)-(13) until Ψ(e′)<10⁻⁵;
Step 3: online optimization of the control strategy based on the action-critic framework;
during an online training process, an output of the critic network can be expressed as
$$\hat{V} ( {e}_{k} , \hat{η} ( {e}_{k} ) ) = {w}_{c 2}^{T} ϕ ( {{w}_{c 1}^{T} [ {e}_{k} , \hat{η} ( {e}_{k} ) ]}^{T} ) \qquad ( 14 )$$
where w_{c1}∈ [symbol] and w_{c2}∈ [symbol] are weight vectors of the critic network; h_{c}=12 represents the number of hidden layer neurons in the critic network; during the online training process, an approximation error of the critic network can be expressed as
$${ε}_{c} ( {e}_{k} ) = γ \hat{V} ( {e}_{k} , Δ {u}_{k} ) - ( \hat{V} ( {e}_{k - 1} , Δ {u}_{k - 1} ) - U ( {e}_{k} , Δ {u}_{k} ) ) \qquad ( 15 )$$
a performance index of the critic network can be expressed as
$${E}_{c} ( {e}_{k} ) = \frac{1}{2} {ε}_{c}^{2} ( {e}_{k} ) \qquad ( 16 )$$
according to the principle of gradient descent, the update rule of the weight vector w_{c2} can be expressed as
$${w}_{c 2} := {w}_{c 2} - {I}_{c} \frac{\partial {E}_{c} ( {e}_{k} )}{\partial {w}_{c 2}} \qquad ( 17 )$$
where l_{c}=0.01 is the learning rate during the online training process of the critic network; during the weight training process, only the outer-layer weight w_{c2} is updated, and the inner-layer weight w_{c1} remains unchanged after being randomly initialized; repeat steps (14)-(17) until E_{c}(eₖ)<10⁻⁵; at this point, update of the critic network at the k moment is completed;
next, based on evaluation results of the control strategy by the critic network, policy improvement is completed; during the online training process, the output of the action network can be expressed as
$$\hat{η} ( {e}_{k} ) = {w}_{a 2}^{T} ϕ ( {w}_{a 1}^{T} {e}_{k} ) \qquad ( 18 )$$
during the online training process, an approximation error of the action network is defined as
$${ε}_{a} ( {e}_{k} ) = \hat{V} ( {e}_{k} , Δ {u}_{k} ) - {U}_{d} \qquad ( 19 )$$
where U_{d} is an ideal training target; where U_{d}=0; a performance index of the action network during the online training process is defined as
$${E}_{a} ( {e}_{k} ) = \frac{1}{2} {ε}_{a}^{2} ( {e}_{k} ) \qquad ( 20 )$$
an update rule of the weight vector wₐ₂ can be expressed as
$${w}_{a 2} := {w}_{a 2} - {I}_{a} \frac{\partial {E}_{a} ( {e}_{k} )}{\partial {w}_{a 2}} \qquad ( 21 )$$
repeat steps (18)-(21) until |∂Eₐ(eₖ)/∂wₐ₂<10⁻³; at this point, optimization of the action network at k moment is completed; finally, use the well-trained action network to calculate the control input based on a current tracking error;
$$\{ \begin{matrix}Δ {u}_{k} = \hat{η} ( {e}_{k} ) \\ {u}_{k} = {u}_{k 1} + Δ {u}_{k}\end{matrix} \qquad ( 22 )$$
the control input Uₖ represents an ideal oxygen transfer coefficient of the wastewater treatment system at a certain moment; once a programmable logic controller (2.2) obtains the ideal value, it instantly calculates a difference between the ideal and actual oxygen transfer coefficients; then, it generates an output signal based on this difference and sends the output signal to a frequency converter (2.3); upon receiving the output signal, the frequency converter (2.3) responds promptly and precisely adjusts its output frequency to a blower (2.4); by doing so, a motor speed of the blower is regulated, thereby changing the amount of air delivered to a tank (1.8) and enabling the actual oxygen transfer coefficient to reach the ideal value; under the action of the ideal oxygen transfer coefficient, the DO concentration in the tank (1.8) is precisely regulated and stabilized near the set value, ensuring the best wastewater treatment effect.
